(19) United States
(12) Patent Application Publication
(10) Pub. No.: US 2026/0292657 A1
(43) Pub. Date: Sep. 24, 2026

(54) SYSTEM INFORMATION CONFIGURATION METHOD/APPARATUS/DEVICE AND STORAGE MEDIUM

(71) Applicant: Beijing Xiaomi Mobile Software Co., Ltd., Beijing (CN)

(72) Inventor: Xing YANG, Beijing (CN)

(73) Assignee: Beijing Xiaomi Mobile Software Co., Ltd., Beijing (CN)

(21) Appl. No.: 18/874,417

(22) PCT Filed: Jun. 21, 2022
(86) PCT No.: PCT/CN2022/100245

§ 371 Date: Dec. 12, 2024

(51) Int. Cl. H04W 48/08; H04W 88/04

(52) U.S. Cl. CPC H04W 48/08; H04W 88/04

(57) ABSTRACT

A system information configuration method includes: receiving system information, which is sent by a network device, and storing same.

### CROSS-REFERENCE TO RELATED APPLICATIONS

The present application is a U.S. National Stage of International Application No. PCT/CN2022/100245, filed on Jun. 21, 2022, the content of which is incorporated by reference herein in its entirety.

### TECHNICAL FIELD

The present disclosure relates to the field of communication technology, and in particular to a system information configuration method/apparatus/device and a storage medium.

### BACKGROUND

In a communication system, a user equipment (UE) may not be directly connected to a base station, but may communicate with the base station through the relay of another UE, where a UE that is not connected to a network device is called a remote UE, and a UE that provides a relay function is called a relay UE.

### SUMMARY

According to a first aspect, the embodiments of the present disclosure provide a method for configuring system information, performed by a relay user equipment UE in a connected state, including:
receiving and storing the system information SIB sent by a network device.

According to a second aspect, the embodiments of the present disclosure provide a method for configuring system information, performed by a network device, including:
sending system information to a relay UE in a connected state.

According to a third aspect, the embodiments of the present disclosure provide a method for configuring system information, performed by a remote UE, including:
sending a first request message to a relay UE in a connected state, where the first request message carries a system information identifier of specific system information requested by the remote UE; and
receiving the specific system information sent by the relay UE.

According to a fourth aspect, the embodiments of the present disclosure provide a communication device, the device is configured in a relay UE, including:
a transceiver module configured to receive and store system information SIB sent by a network device.

According to a fifth aspect, the embodiments of the present disclosure provide a communication device, the device is configured in a network device, including:
a transceiver module configured to send system information SIB to a relay UE in a connected state.

According to a sixth aspect, the embodiments of the present disclosure provide a communication device, the device is configured in a remote UE, including:
a transceiver module configured to send a first request message to a relay UE in a connected state, where the first request message carries a system information identifier of specific system information requested by a remote UE; and
a transceiver module configured to receive the specific system information sent by the relay UE.

According to a seventh aspect, the embodiments of the present disclosure provide a communication device, including a processor, where the device is configured to perform the method according to the first aspect upon the processor calling a computer program in a memory.

According to an eighth aspect, the embodiments of the present disclosure provide a communication device, including a processor, where the device is configured to perform the method according to the second aspect upon the processor calling a computer program in a memory.

According to a ninth aspect, the embodiments of the present disclosure provide a communication device, including a processor, where the device is configured to perform the method according to the third aspect upon the processor calling a computer program in a memory.

According to a tenth aspect, the embodiments of the present disclosure provide a communication device, including a processor and a memory, where the memory stores a computer program, and the communication device is configured to perform the method according to the first aspect upon the processor executing the computer program stored in the memory.

According to an eleventh aspect, the embodiments of the present disclosure provide a communication device, including a processor and a memory, where the memory stores a computer program, and the communication device is configured to perform the method according to the second aspect upon the processor executing the computer program stored in the memory.

According to a twelfth aspect, the embodiments of the present disclosure provide a communication device, including a processor and a memory, where the memory stores a computer program, and the communication device is configured to perform the method according to the third aspect upon the processor executing the computer program stored in the memory.

According to a thirteenth aspect, the embodiments of the present disclosure provide a communication device, including a processor and an interface circuit, where the interface circuit is configured to receive a code instruction and transmit it to the processor, the processor is configured to run the code instruction to perform the method according to the first aspect.

According to a fourteenth aspect, the embodiments of the present disclosure provide a communication device, including a processor and an interface circuit, where the interface circuit is configured to receive a code instruction and transmit it to the processor, the processor is configured to run the code instruction to perform the method according to the second aspect.

According to a fifteenth aspect, the embodiments of the present disclosure provide a communication device, including a processor and an interface circuit, where the interface circuit is configured to receive a code instruction and transmit it to the processor, the processor is configured to run the code instruction to perform the method according to the third aspect.

According to a sixteenth aspect, the embodiments of the present disclosure provide a communication system, including the communication device according to the fourth aspect to the communication device according to the sixth aspect, or including the communication device according to the seventh aspect to the communication device according to the ninth aspect, or including the communication device according to the tenth aspect to the communication device according to the twelfth aspect, or including the communication device according to the thirteenth aspect to the communication device according to the fifteenth aspect.

According to a seventeenth aspect, the embodiments of the present disclosure provide a non-transitory computer-readable storage medium, for storing instructions used by the network device, when the instructions are executed, the terminal device is configured to perform the method according to any one of the first aspect to the third aspect.

According to an eighteenth aspect, the present disclosure provides a computer program product including a computer program, a computer is configured to perform the method according to any one of the first aspect to the third aspect upon executing the computer program product on the computer.

According to a nineteenth aspect, the present disclosure provides a chip system. The chip system includes at least one processor and an interface for supporting function involved in implementing the method according to any one of the first aspect to the third aspect, for example, determining or processing at least one of data and information involved in the above methods. In one possible implementation, the chip system further includes a memory for storing computer programs and data essential for the source and auxiliary nodes. The chip system may include a chip, or may include a chip and other separate components.

According to a twentieth aspect, the present disclosure further provides a computer program product including a computer program. When the computer program product is run on a computer, the computer is configured to perform the method according to any one of the first aspect to the third aspect.

### BRIEF DESCRIPTION OF THE DRAWINGS

The above and/or additional aspects and advantages of the present disclosure will become apparent and easy to understand from the following description of the embodiments in conjunction with the accompanying drawings, in which:

FIG. 1 is a schematic diagram of an architecture of a communication system provided by embodiments of the present disclosure;

FIG. 2 is a schematic diagram of a flow chart of a system information configuration method provided by an embodiment of the present disclosure;

FIG. 3 is a schematic diagram of a flow chart of a system information configuration method provided by another embodiment of the present disclosure;

FIG. 4 is a schematic diagram of a flow chart of a system information configuration method provided by yet another embodiment of the present disclosure;

FIG. 5a is a schematic diagram of a flow chart of a system information configuration method provided by yet another embodiment of the present disclosure;

FIG. 5b is a schematic diagram of a flow chart of a system information configuration method provided by yet another embodiment of the present disclosure;

FIG. 6a is a schematic diagram of a flow chart of a system information configuration method provided by yet another embodiment of the present disclosure;

FIG. 6b is a schematic diagram of a flow chart of a system information configuration method provided by yet another embodiment of the present disclosure;

FIG. 7 is a schematic diagram of a flow chart of a system information configuration method provided by yet another embodiment of the present disclosure;

FIG. 8 is a schematic diagram of a flow chart of a system information configuration method provided by yet another embodiment of the present disclosure;

FIG. 9a is a schematic diagram of a flow chart of a system information configuration method provided by yet another embodiment of the present disclosure;

FIG. 9b is a schematic diagram of a flow chart of a system information configuration method provided by yet another embodiment of the present disclosure;

FIG. 10a is a schematic diagram of a flow chart of a system information configuration method provided by yet another embodiment of the present disclosure;

FIG. 10b is a schematic diagram of a flow chart of a system information configuration method provided by yet another embodiment of the present disclosure;

FIG. 11 is a schematic diagram of a flow chart of a system information configuration method provided by yet another embodiment of the present disclosure;

FIG. 12 is a structural diagram of a system information configuration device provided by an embodiment of the present disclosure;

FIG. 13 is a structural diagram of a system information configuration device provided by another embodiment of the present disclosure;

FIG. 14 is a structural diagram of a system information configuration device provided by yet another embodiment of the present disclosure;

FIG. 15 is a block diagram of a terminal device provided by an embodiment of the present disclosure;

FIG. 16 is a block diagram of a network side device provided by an embodiment of the present disclosure.

### DETAILED DESCRIPTION

Here, embodiments will be described in detail, examples of which are shown in the accompanying drawings. When the following description refers to the drawings, unless otherwise indicated, the same numbers in different drawings represent the same or similar elements. The embodiments described in the following example embodiments do not represent all embodiments consistent with the embodiments of the present disclosure. Instead, they are only examples of devices and methods consistent with some aspects of the embodiments of the present disclosure as detailed in the attached claims.

The terms used in the embodiments of the present disclosure are only for the purpose of describing specific embodiments and are not intended to limit the embodiments of the present disclosure. The singular forms “a”, “an” and “the” used in the embodiments of the present disclosure and the attached claims are also intended to include the plural forms unless the context clearly indicates other meanings. It should also be understood that the term “and/or” used herein refers to and includes any or all possible combinations of one or more associated listed items.

It should be understood that although the terms first, second, third, etc. may be used in the embodiments of the present disclosure to describe various information, the information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the words “if” as used herein can be interpreted as “upon . . . ” or “when . . . ” or “in response to determining”.

In order to better understand a method for configuring system information disclosed in an embodiment of the present disclosure, the following first describes a communication system to which the embodiment of the present disclosure is applicable.

For ease of understanding, the terms involved in this application are first introduced.

### 1. Sidelink (SL)

Sidelink communication is classified into two modes. One is called discovery between UEs, and the other is called communication between UEs. Sidelink uses uplink resources and uplink physical channels similar to cellular networks (LTE) for data interactive transmission.

### 2. Remote UE

A UE that does not communicate directly with a base station but communicates with a base station through other UE.

### 3. Relay UE

A UE configured to implement relay communication between other UE and a base station.

### 4. Ratio Resource Control (RRC) Signaling

RRC signaling can provide a parameter configuration function for the underlying protocol entity of the access network; it is responsible for measurement, control and other functions related to terminal device mobility management.

### 5. System Information Block (SIB)

SIB contains a lot of system information. For example, SIBI contains the parameters related to the UE's evaluation of whether it can access the current cell and system scheduling, and SIB2 mainly contains public wireless resource configuration information, timers and constants, cell access prohibition information, etc.

### 6. Preamble

The preamble can be used for signal detection, time synchronization, frequency offset estimation, channel estimation, etc.

The following describes the embodiments of the present disclosure in detail, and examples of the embodiments are shown in the accompanying drawings, where the same or similar reference numerals throughout represent the same or similar elements. The embodiments described below with reference to the accompanying drawings are examples and are intended to be used to explain the present disclosure, and cannot be understood as limiting the present disclosure.

In the related art, a remote UE may send a first request message to a relay UE. The first request message carries an identifier of the system information requested by the remote UE. After receiving the first request message, the relay UE determines the system information requested by the remote UE, and then sends a second request message to the network device to request the system information requested by the remote UE from the network device, and forwards the system information to the remote UE after receiving the system information sent by the network device based on the second request message.

However, in the related art, for a relay UE in a connected state, it can only request SIB12, SIB13, SIB14, SIB20 and SIB21 in the system information from the network device, but a remote UE in an idle state or an inactive state can request any system information from the relay UE. Based on this, if the remote UE in the idle state or the inactive state requests system information other than SIB12, SIB13, SIB14, SIB20 and SIB21 from the relay UE in the connected state, since the relay UE in the connected state cannot request system information other than SIB12, SIB13, SIB14, SIB20 and SIB21 from the network device, the relay UE in the connected state cannot obtain the system information requested by the remote UE from the network device, which will cause the system information request to fail and affect communication stability.

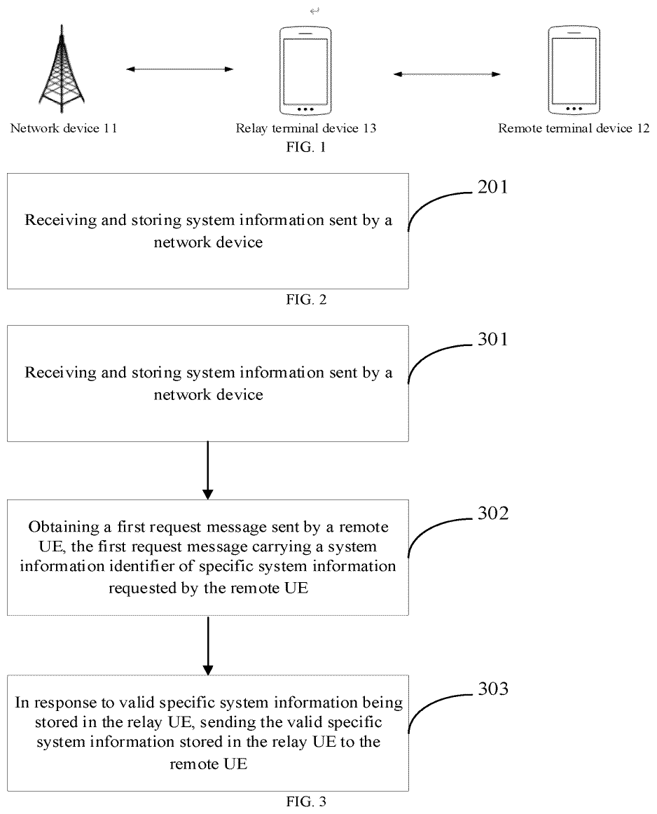

FIG. 1 is a schematic diagram of an architecture of a communication system provided by embodiments of the present disclosure. The communication system may include, but is not limited to, a network device, a remote terminal device and a relay terminal device. The number and form of the devices shown in FIG. 1 are only used as examples and do not constitute a limitation on the embodiments of the present disclosure. In actual applications, two or more network devices and two or more terminal devices may be included. The communication system shown in FIG. 1 includes a network device 11, a remote terminal device 12, and a relay terminal device 13 as an example.

It should be noted that the technical solution of the embodiment of the present disclosure can be applied to various communication systems. For example: long term evolution (LTE) system, fifth generation (5G) mobile communication system, 5G new radio (NR) system, or other future new mobile communication systems.

The network device 11 in the embodiment of the present disclosure is an entity on the network side for transmitting or receiving signals. For example, the network device 11 can be an evolved NodeB (eNB), a transmission reception point (TRP), a next generation NodeB (gNB) in an NR system, a base station in other future mobile communication system, or an access node in a wireless fidelity (WiFi) system. The embodiment of the present disclosure does not limit the specific technology and specific device form adopted by the network device. The network device provided in the embodiment of the present disclosure may include a central unit (CU) and a distributed unit (DU). The CU may also be referred to as a control unit. The CU-DU structure may be configured to split the protocol layers of the network device, such as a base station, and the functions of some protocol layers are centrally controlled by the CU, while the functions of the remaining part or all of the protocol layers are distributed in the DU, and the DU is centrally controlled by the CU.

The remote terminal device 12 and the relay terminal device 13 in the embodiment of the present disclosure may be an entity on the user side for receiving or transmitting signals, such as a mobile phone. The terminal device may also be referred to as a terminal, a user equipment (UE), a mobile station (MS), a mobile terminal (MT), etc. The terminal device may be a car with communication function, a smart car, a mobile phone, a wearable device, a tablet computer (pad), a computer with wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The embodiments of the present disclosure do not limit the specific technology and specific device form adopted by the terminal device.

It can be understood that the communication system described in the embodiments of the present disclosure is to more clearly illustrate the technical solution of the embodiments of the present disclosure, and does not constitute a limitation on the technical solution provided by the embodiments of the present disclosure. It can be known to those skilled in the art that with the evolution of the system architecture and the emergence of new business scenarios, the technical solution provided by the embodiments of the present disclosure is also applicable to similar technical problems.

The embodiments of the present disclosure are described in detail below. Examples of the embodiments are shown in the accompanying drawings, in which the same or similar reference numerals throughout represent the same or similar elements. The embodiments described below with reference to the accompanying drawings are examples and are intended to be used to explain the present disclosure, but cannot be understood as limiting the present disclosure.

FIG. 2 is a flow chart of a system information configuration method provided by an embodiment of the present disclosure, which is applied to a relay UE in a connected state. As shown in FIG. 2, the system information configuration method may include the following steps:
Step 201, receiving and storing system information sent by a network device.

In one embodiment of the present disclosure, the method for receiving and storing system information sent by the network device may include at least one or more of the following:
Method 1: receiving the first type of system information sent by the network device based on a request of a third system information request message.

In one embodiment of the present disclosure, the third system information request message may be a DedicatedSIBRequest. And, the third system information request message may indicate the system information to be requested, such as including an identifier of the requested system information. After that, the relay UE can receive the system information indicated by the third system information request message sent by the network device by sending the third system information request message to the network device.

It should be noted that, in one embodiment of the present disclosure, the third system information request message does not support indicating all system information, but only supports indicating part of the system information. Based on this, the above-mentioned first type of system information may include system information that the relay UE in the connected state can indicate through the third system information request message. For example, in one embodiment of the present disclosure, the first type of system information may include at least one of SIB12, SIB13, SIB14, SIB20 and SIB21.
Method 2: receiving system information other than the first type of system information sent by the network device based on a request of a fourth system information request message.

In one embodiment of the present disclosure, for system information that cannot be indicated by the above-mentioned third system information request message (that is, system information other than the first type of system information), it can be obtained through the fourth system information request message. Specifically, the relay UE can obtain the system information requested by the fourth system information request message sent by the network device by sending the fourth system information request message to the network device.

Further, in one embodiment of the present disclosure, the fourth system information request message may be a preamble or a radio resource control system information request RRCSystemInfoRequest. It should be noted that the sending situations of the above-mentioned preamble or RRCSystemInfoRequest are also different.

Specifically, in one embodiment of the present disclosure, there is a corresponding relationship between the preamble and the system information, and the preamble can be specifically configured to request the system information corresponding to the preamble. The corresponding relationship between the preamble and the system information can be indicated to the relay UE by the network device through si-RequestConfig in SIB1. That is, the network device will indicate which preamble should be used to request a certain system message through si-RequestConfig in SIB1. Based on this, when the relay UE wants to request a piece of system information other than the first type of system information, if the network device configures the corresponding preamble for the piece of system information, the relay UE can receive the corresponding system information sent by the network device to the relay UE based on the preamble by sending the preamble corresponding to the piece of system information to the network device; if the network device does not configure the corresponding preamble for the piece of system information, the relay UE can send RRCSystemInfoRequest to the network device, where the RRCSystemInfoRequest includes an identifier of the piece of system information, so that the relay UE can receive the corresponding system information sent by the network device to the relay UE based on the identifier of the system information.

That is to say, in the embodiment of the present disclosure, when the relay UE in the connected state receives a system message other than SIB12, SIB13, SIB14, SIB20 and SIB21 requested by the remote UE, the UE cannot request the system message from the network device through DedicatedSIBRequest. At this time, the relay UE in the connected state can request the system message through preamble or RRCSystemInfoRequest to enable the remote UE to obtain system messages other than SIB12, SIB13, SIB14, SIB20 and SIB21.
Method 3: receiving system information other than the first type of system information sent by the network device.

In one embodiment of the present disclosure, for system information that cannot be indicated by the third system information request message (i.e., system information other than the first type of system information), the relay UE may not request the network device, but the network device may actively send it to the relay UE.

It should be noted that in one embodiment of the present disclosure, the method for the network device to send the first type of system information, or system information other than the first type of system information, to the relay UE may be at least one of the following:

Sending the first type of system information, or system information other than the first type of system information, to the relay UE in the connected state through an RRC reconfiguration message.

Broadcasting the first type of system information, or system information other than the first type of system information, to the relay UE in the connected state.

For example, the network device may send all system information to the relay UE in the connected state through an RRC reconfiguration message; or, the network device may provide part of the system information through broadcasting, and provide unbroadcasted system information through an RRC reconfiguration message.

It can be seen from the above methods 1 to 3 that in one embodiment of the present disclosure, for a relay UE in a connected state, it has the ability to obtain all system information from a network device. Specifically, it can obtain all system information based on a request (such as obtaining the first type of system information based on a third system information request message, and obtaining system information other than the first type of system information based on a fourth system information request message), or, obtain part of the system information based on a request and obtain other remaining system information actively sent by the network device (such as obtaining the first type of system information based on a third system information request message, and obtaining system information other than the first type of system information actively sent by the network device). Based on this, when a remote UE in an idle state or an inactive state requests any system information from a relay UE in a connected state, the relay UE in the connected state can obtain the system information requested by the remote UE in the idle state or the inactive state from the network device (e.g., the relay UE in the connected state can obtain the system information required by the remote UE based on the request, or the relay UE in the connected state can obtain the system information required by the remote UE actively sent by the network device), and forward it to the remote UE, thereby ensuring that the remote UE can successfully request any system information and avoiding a situation where “when a remote UE in an idle state or an inactive state requests other SIBs except SIB12, SIB13, SIB14, SIB20 and SIB21 from a relay UE in a connected state, since the relay UE in the connected state can only request SIB12, SIB13, SIB14, SIB20 and SIB21 from the network device, the relay UE in the connected state cannot successfully obtain the other SIBs requested by the remote UE, which leads to the remote UE's failure to request the other SIBs. This ensures the stability of SL communication.

In summary, in the system information configuration method provided in the embodiment of the present disclosure, the relay UE in the connected state receives and stores the system information sent by the network device. The method for the relay UE in the connected state to receive the system information sent by the network device can be: the relay UE in the connected state obtains the system information required by the remote UE based on the request, or the relay UE in the connected state obtains the system information required by the remote UE actively sent by the network device. Based on this, when a remote UE in an idle state or an inactive state requests any system information from a relay UE in a connected state, the relay UE in the connected state can obtain the system information requested by the remote UE in the idle state or the inactive state from the network device and forward it to the remote UE, thereby ensuring that the remote UE can successfully request any system information and ensuring the stability of communication.

FIG. 3 is a flow chart of a system information configuration method provided by an embodiment of the present disclosure, which is applied to a relay UE in a connected state. As shown in FIG. 3, the system information configuration method may include the following steps:
Step 301, receiving and storing system information sent by a network device.

For a detailed description of step 301, refer to the above embodiment description.
Step 302, obtaining a first request message sent by a remote UE, the first request message carrying a system information identifier of specific system information requested by the remote UE.

In one embodiment of the present disclosure, the remote UE and the relay UE can be connected via SL communication.

In one embodiment of the present disclosure, when the remote UE is in different states, the first request message sent by the remote UE to the relay UE will be different.

Specifically, in one embodiment of the present disclosure, when the remote UE is in an idle state or an inactive state, the first request message may be a sidelinkRRC message, for example, a RemoteUEInformationSidelink message. The first request message sent by the remote UE in the idle state or the inactive state may request any system information. If the remote UE is in a connected state, the first request message may be a DedicatedSIBRequest, where the first request message sent by the remote UE in the connected state may request the first type of system information. The introduction of the first type of system information may refer to the above-mentioned embodiment description.
Step 303, in response to valid specific system information being stored in the relay UE, sending the valid specific system information stored in the relay UE to the remote UE.

In one embodiment of the present disclosure, the valid specific system information is specifically the latest version of the system information.

In one embodiment of the present disclosure, the network device will indicate the latest version number of each system information in SIB1. Based on this, the method for the relay UE to determine that it has stored valid specific system information can be:
determining the latest version number of the specific system information requested by the remote UE based on the SIBI broadcast by the network device, and determining the version number of the specific system information stored by the relay UE itself; if the version number of the specific system information stored by the relay UE itself is the latest version number, determining that the relay UE has stored the valid specific system information. At this time, the specific system information stored by the relay UE itself can be directly sent to the remote UE.

In one embodiment of the present disclosure, the relay UE in the connected state can specifically send the specific system information to the remote UE through a sidelinkRRC message (for example, UuMessageTransferSidelink).

In summary, in the system information configuration method provided in the embodiment of the present disclosure, the relay UE in the connected state will receive and store the system information sent by the network device. The method for the relay UE in the connected state to receive the system information sent by the network device can be: the relay UE in the connected state obtains the system information required by the remote UE based on the request, or the relay UE in the connected state obtains the system information required by the remote UE actively sent by the network device. Based on this, when the remote UE in the idle state or the inactive state requests any system information from the relay UE in the connected state, the relay UE in the connected state can obtain the system information requested by the remote UE in the idle state or the inactive state from the network device and forward it to the remote UE, thereby ensuring that the remote UE can successfully request any system information and ensuring the stability of communication.

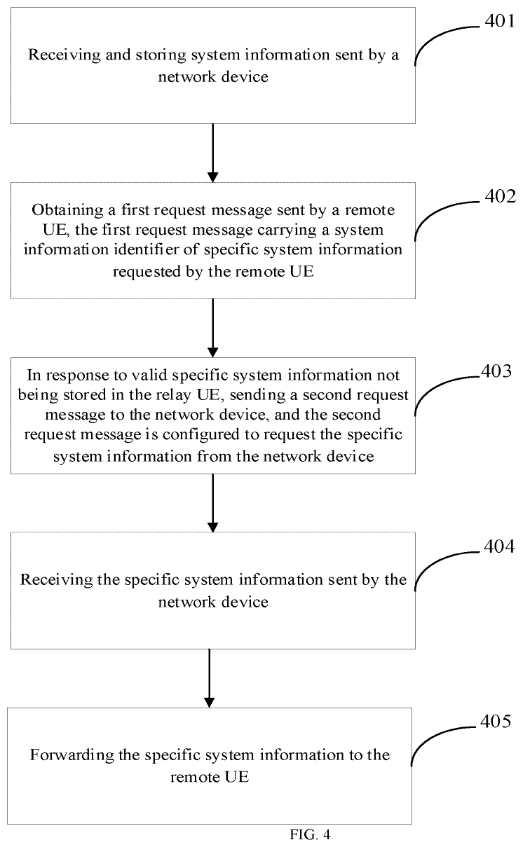

FIG. 4 is a flow chart of a system information configuration method provided by an embodiment of the present disclosure, which is applied to a relay UE in a connected state. As shown in FIG. 4, the system information configuration method may include the following steps:
Step 401, receiving and storing system information sent by a network device.
Step 402, obtaining a first request message sent by a remote UE, the first request message may carry a system information identifier of specific system information requested by the remote UE.

The relevant introduction of steps 401-402 can refer to the description of the above embodiment.
Step 403: in response to valid specific system information not being stored in the relay UE, sending a second request message to the network device, and the second request message is configured to request the specific system information from the network device.

In one embodiment of the present disclosure, the valid specific system information is specifically the latest version of the system information.

In one embodiment of the present disclosure, the network device will indicate the latest version number of each system information in SIB1. Based on this, the method for the relay UE to determine that it does not store valid specific system information can be:
determining the latest version number of the specific system information requested by the remote UE based on the SIB1 broadcast by the network device, and determining the version number of the specific system information stored by the relay UE itself; if the version number of the specific system information stored by the relay UE itself is not the latest version number, determining that the relay UE does not store the valid specific system information. At this time, the relay UE needs to send a second request message to the network device to request to obtain the latest version of the specific system information from the network device, and forward the obtained latest version of the specific system information to the remote UE.

In one embodiment of the present disclosure, the second request message may be DedicatedSIBRequest, and in another embodiment of the present disclosure, the second request message may be preamble or RRCSystemInfoRequest. Details on when the relay UE sends a DedicatedSIBRequest to the network device and when it sends a preamble or RRCSystemInfoRequest to the network device will be described in detail in the following embodiments.

Further, it should be noted that in one embodiment of the present disclosure, after the relay UE in the connected state sends the second request message to the network device, a timer (such as T350 timer) may be started, and during the timer, the relay UE in the connected state cannot send the second request message again, thereby avoiding the relay UE in the connected state from repeatedly sending useless second request messages, and thus saving signaling overhead.

In addition, it should be noted that in one embodiment of the present disclosure, the network device may also indicate whether the relay UE can send the second request message in the connected state through onDemandSIB-Request, and in response to the network device indicating that the relay UE can send the second request message in the connected state, the relay UE may send the second request message to the network device in the connected state. Among them, onDemandSIB-Request can be specifically carried by the RRC reconfiguration message and sent to the relay UE.
Step 404, receiving the specific system information sent by the network device.

In one embodiment of the present disclosure, the specific system information sent by the network device to the UE in this step is the latest version of the specific system information.
Step 405, forwarding the specific system information to the remote UE.

In summary, in the system information configuration method provided in the embodiment of the present disclosure, the relay UE in the connected state will receive and store the system information sent by the network device. The method for the relay UE in the connected state to receive the system information sent by the network device can be: the relay UE in the connected state obtains the system information required by the remote UE based on the request, or the relay UE in the connected state obtains the system information required by the remote UE actively sent by the network device. Based on this, when a remote UE in an idle state or an inactive state requests any system information from a relay UE in a connected state, the relay UE in the connected state can obtain the system information requested by the remote UE in the idle state or the inactive state from the network device and forward it to the remote UE, thereby ensuring that the remote UE can successfully request any system information and ensuring the stability of communication.

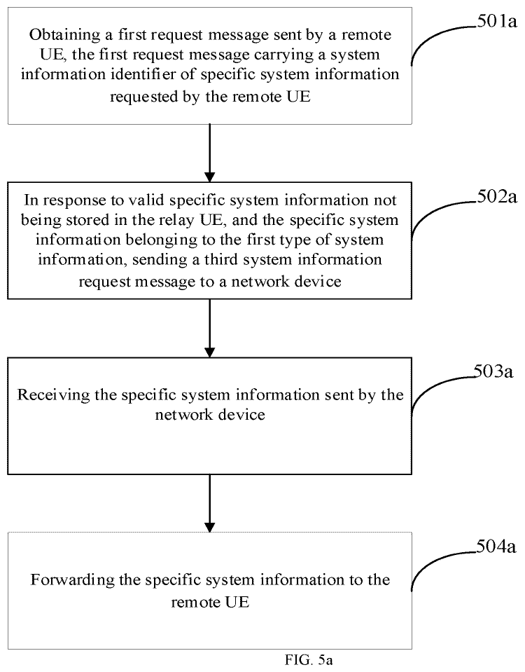

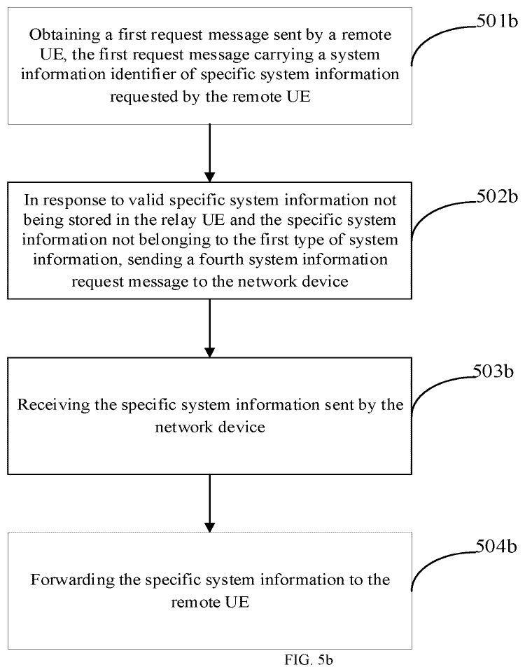

FIG. 5a is a flow chart of a system information configuration method provided by an embodiment of the present disclosure, which is applied to a relay UE in a connected state. As shown in FIG. 5a, the system information configuration method may include the following steps:
Step 501a, obtaining a first request message sent by a remote UE, the first request message carrying a system information identifier of specific system information requested by the remote UE.

The relevant introduction of step 501a can refer to the description of the above embodiment.
Step 502a, in response to valid specific system information not being stored in the relay UE, and the specific system information belonging to the first type of system information, sending a third system information request message to a network device.

In one embodiment of the present disclosure, the third system information request message may be DedicatedSIBRequest, and the third system information request message may request the first type of system information from the network device by indicating the first type of system information.

Therefore, in one embodiment of the present disclosure, when the relay UE does not store the valid specific system information, the relay UE needs to obtain the specific system information by requesting it from the network device. On this basis, when the specific system information requested by the first request message belongs to the first type of system information, it means that the third system information can indicate the specific system information. Therefore, the relay UE in the connected state can request the specific system information by sending a third system information request message to the network device.
Step 503a, receiving the specific system information sent by the network device.
Step 504a, forwarding the specific system information to the remote UE.

In summary, in the system information configuration method provided in the embodiment of the present disclosure, the relay UE in the connected state will receive and store the system information sent by the network device. The method for the relay UE in the connected state to receive the system information sent by the network device can be: the relay UE in the connected state obtains the system information required by the remote UE based on the request, or the relay UE in the connected state obtains the system information required by the remote UE actively sent by the network device. Based on this, when a remote UE in an idle state or an inactive state requests any system information from a relay UE in a connected state, the relay UE in the connected state can obtain the system information requested by the remote UE in the idle state or the inactive state from the network device and forward it to the remote UE, thereby ensuring that the remote UE can successfully request any system information and ensuring the stability of communication.

FIG. 5b is a flow chart of a system information configuration method provided by an embodiment of the present disclosure, which is applied to a relay UE in a connected state. As shown in FIG. 5b, the system information configuration method may include the following steps:
Step 501b, obtaining a first request message sent by a remote UE, the first request message carrying a system information identifier of specific system information requested by the remote UE.

The relevant introduction of step 501b can refer to the description of the above embodiment.
Step 502b, in response to valid specific system information not being stored in the relay UE and the specific system information not belonging to the first type of system information, sending a fourth system information request message to the network device.

In one embodiment of the present disclosure, when the relay UE does not store the valid specific system information, the relay UE needs to obtain the specific system information by requesting it from the network device. On this basis, when the specific system information does not belong to the first type of system information, it means that the third system information cannot be used to indicate the specific system information. Therefore, the relay UE needs to request the specific system information by sending a fourth system information request message to the network device.

In one embodiment of the present disclosure, the fourth system information request message can be a preamble or an RRCSystemInfoRequest message. Details on when the relay UE sends the preamble to the network device and when it sends the RRCSystemInfoRequest to the network device will be described in detail in the following embodiments.
Step 503b, receiving the specific system information sent by the network device.
Step 504b, forwarding the specific system information to the remote UE.

In summary, in the system information configuration method provided in the embodiment of the present disclosure, the relay UE in the connected state will receive and store the system information sent by the network device. The method for the relay UE in the connected state to receive the system information sent by the network device can be: the relay UE in the connected state obtains the system information required by the remote UE based on the request, or the relay UE in the connected state obtains the system information required by the remote UE actively sent by the network device. Based on this, when the remote UE in the idle state or the inactive state requests any system information from the relay UE in the connected state, the relay UE in the connected state can obtain the system information requested by the remote UE in the idle state or the inactive state from the network device and forward it to the remote UE, thereby ensuring that the remote UE can successfully request any system information and ensuring the stability of communication.

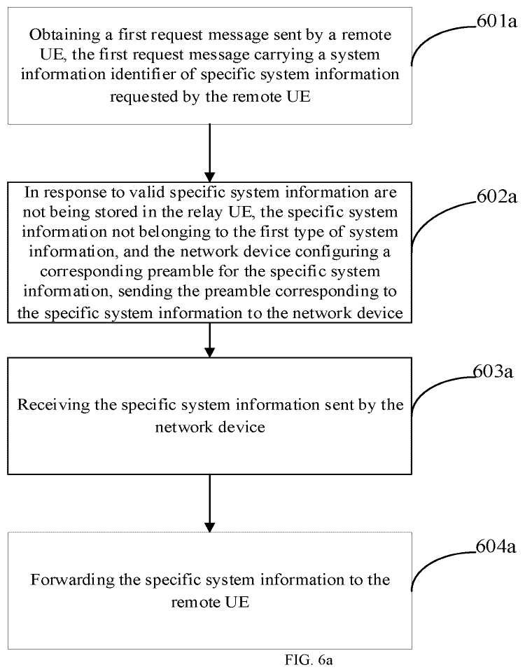

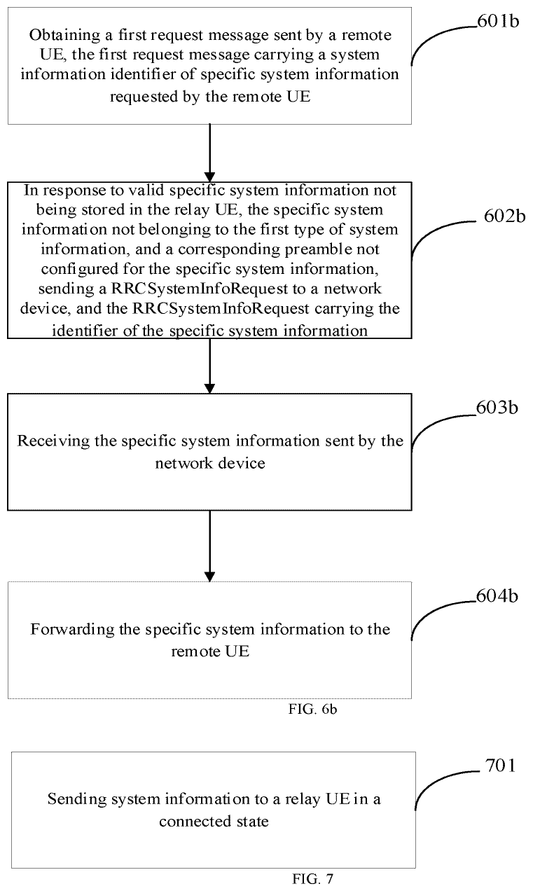

FIG. 6a is a flow chart of a system information configuration method provided by an embodiment of the present disclosure, which is applied to a relay UE in a connected state. As shown in FIG. 6a, the system information configuration method may include the following steps:
Step 601a, obtaining a first request message sent by a remote UE, the first request message carrying a system information identifier of specific system information requested by the remote UE.

Other related introductions of step 601a can refer to the description of the above embodiment.
Step 602a, in response to valid specific system information are not being stored in the relay UE, the specific system information not belonging to the first type of system information, and the network device configuring a corresponding preamble for the specific system information, sending the preamble corresponding to the specific system information to the network device.

In one embodiment of the present disclosure, there may be a corresponding relationship between the preamble and the system information, and the preamble is configured to request the system information corresponding to the preamble.

In one embodiment of the present disclosure, the network device may configure the corresponding relationship between the preamble and the system information through si-RequestConfig in SIB1.
Step 603a, receiving the specific system information sent by the network device.

In one embodiment of the present disclosure, the specific system information is the system information corresponding to the preamble sent based on the preamble after the network device receives the preamble sent by the relay UE.

In one embodiment of the present disclosure, the methods used in steps 602a-603a refer to method 2 in step 201 in the embodiment of FIG. 2 above.
Step 604a, forwarding the specific system information to the remote UE.

In summary, in the system information configuration method provided in the embodiment of the present disclosure, the relay UE in the connected state will receive and store the system information sent by the network device. The method for the relay UE in the connected state to receive the system information sent by the network device can be: the relay UE in the connected state obtains the system information required by the remote UE based on the request, or the relay UE in the connected state obtains the system information required by the remote UE actively sent by the network device. Based on this, when the remote UE in the idle state or the inactive state requests any system information from the relay UE in the connected state, the relay UE in the connected state can obtain the system information requested by the remote UE in the idle state or the inactive state from the network device and forward it to the remote UE, thereby ensuring that the remote UE can successfully request any system information and ensuring the stability of communication.

FIG. 6b is a flow chart of a system information configuration method provided in the embodiment of the present disclosure, which is applied to a relay UE in a connected state. As shown in FIG. 6b, the system information configuration method may include the following steps:
Step 601b, obtaining a first request message sent by a remote UE, the first request message carrying a system information identifier of specific system information requested by the remote UE.

Other related introductions of step 601a can refer to the description of the above embodiment.
Step 602b, in response to valid specific system information not being stored in the relay UE, the specific system information not belonging to the first type of system information, and a corresponding preamble not configured for the specific system information, sending a RRCSystemInfoRequest to a network device, and the RRCSystemInfoRequest carrying the identifier of the specific system information.
Step 603b, receiving the specific system information sent by the network device.

In one embodiment of the present disclosure, as for the method used in steps 602b-603b, please refer to method 2 in step 201 in the embodiment of FIG. 2 above.
Step 604b, forwarding the specific system information to the remote UE.

In summary, in the system information configuration method provided in the embodiment of the present disclosure, the relay UE in the connected state will receive and store the system information sent by the network device. The method for the relay UE in the connected state to receive the system information sent by the network device can be: the relay UE in the connected state obtains the system information required by the remote UE based on the request, or the relay UE in the connected state obtains the system information required by the remote UE actively sent by the network device. Based on this, when a remote UE in an idle state or an inactive state requests any system information from a relay UE in a connected state, the relay UE in the connected state can obtain the system information requested by the remote UE in the idle state or the inactive state from the network device and forward it to the remote UE, thereby ensuring that the remote UE can successfully request any system information and ensuring the stability of communication.

FIG. 7 is a flow chart of a system information configuration method provided by an embodiment of the present disclosure, which is applied to a network device. As shown in FIG. 7, the system information configuration method may include the following steps:
Step 701, sending system information to a relay UE in a connected state.

In one embodiment of the present disclosure, when the network device determines that a certain UE is a relay UE, it will send system information to the relay UE.

In one embodiment of the present disclosure, the method for determining that a UE is a relay UE in a connected state includes at least one or more of the following;
in response to determining that a UE requests resource to send a relay discovery message, the UE is determined to be a relay UE in a connected state;
in response to determining that a UE requests sending resource for a relay communication, it means that the UE is a relay UE in a connected state and is connected to a remote UE, and the UE is determined to be a relay UE in a connected state; and
in response to determining that a UE sends a paging identifier of a remote UE, it means that the UE is a relay UE in a connected state and is connected to a remote UE in an idle state or an inactive state, and the UE is determined to be a relay UE in a connected state.

In one embodiment of the present disclosure, the method for a network device to send system information to a relay UE in a connected state includes at least one of the following:
Method 1: sending the first type of system information to the relay UE based on a request of a third system information request message, the first type of system information includes system information that the relay UE in the connected state can indicate through the third system information request message.
Method 2: sending system information other than the first type of system information to the relay UE based on a request of a fourth system information request message.
Method 3: sending system information other than the first type of system information to the relay UE.

The network device can send system information to the relay UE in the connected state through the RRC reconfiguration message, or broadcast the system information to the relay UE in the connected state.

Other related introductions of step 701 can refer to the description of the above embodiment.

In summary, in the system information configuration method provided in the embodiment of the present disclosure, the relay UE in the connected state will receive and store the system information sent by the network device. The method for the relay UE in the connected state to receive the system information sent by the network device can be: the relay UE in the connected state obtains the system information required by the remote UE based on the request, or the relay UE in the connected state obtains the system information required by the remote UE actively sent by the network device. Based on this, when the remote UE in the idle state or the inactive state requests any system information from the relay UE in the connected state, the relay UE in the connected state can obtain the system information requested by the remote UE in the idle state or the inactive state from the network device and forward it to the remote UE, thereby ensuring that the remote UE can successfully request any system information and ensuring the stability of communication.

FIG. 8 is a flow chart of a system information configuration method provided by an embodiment of the present disclosure, which is applied to a network device. As shown in FIG. 8, the system information configuration method may include the following steps:
Step 801, receiving a second request message sent by a relay UE in a connected state, the second request message being configured to request specific system information.
Step 802, sending the specific system information to the relay UE in the connected state.

For the relevant introduction of steps 801 to 802, reference may be made to the description of the above embodiment.

In summary, in the system information configuration method provided in the embodiment of the present disclosure, the relay UE in the connected state will receive and store the system information sent by the network device. The method for the relay UE in the connected state to receive the system information sent by the network device can be: the relay UE in the connected state obtains the system information required by the remote UE based on the request, or the relay UE in the connected state obtains the system information required by the remote UE actively sent by the network device. Based on this, when the remote UE in the idle state or the inactive state requests any system information from the relay UE in the connected state, the relay UE in the connected state can obtain the system information requested by the remote UE in the idle state or the inactive state from the network device and forward it to the remote UE, thereby ensuring that the remote UE can successfully request any system information and ensure the stability of communication.

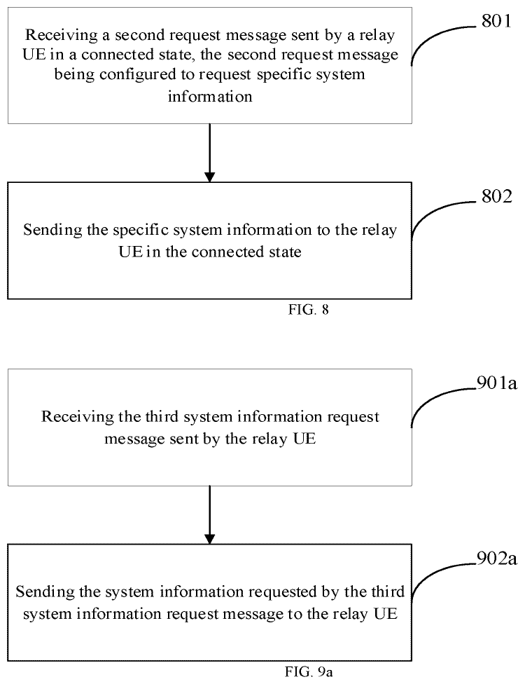

FIG. 9a is a flow chart of a system information configuration method provided in the embodiment of the present disclosure, which is applied to the network device. As shown in FIG. 9a, the system information configuration method may include the following steps:
Step 901a, receiving the third system information request message sent by the relay UE.
Step 902a, sending the system information requested by the third system information request message to the relay UE.

The relevant introduction of steps 901a to 902a can refer to the description of the above embodiment.

In summary, in the system information configuration method provided in the embodiment of the present disclosure, the relay UE in the connected state will receive and store the system information sent by the network device. The method for the relay UE in the connected state to receive the system information sent by the network device can be: the relay UE in the connected state obtains the system information required by the remote UE based on the request, or the relay UE in the connected state obtains the system information required by the remote UE actively sent by the network device. Based on this, when the remote UE in the idle state or the inactive state requests any system information from the relay UE in the connected state, the relay UE in the connected state can obtain the system information requested by the remote UE in the idle state or the inactive state from the network device and forward it to the remote UE, thereby ensuring that the remote UE can successfully request any system information and ensure the stability of communication.

FIG. 9b is a flow chart of a system information configuration method provided in the embodiment of the present disclosure, which is applied to a network device. As shown in FIG. 9b, the system information configuration method may include the following steps:
Step 901b, receiving a fourth system information request message sent by a relay UE.
Step 902b, sending system information requested by the fourth system information request message to the relay UE.

The relevant introduction of steps 901b to 902b can refer to the description of the above embodiment.

In summary, in the system information configuration method provided in the embodiment of the present disclosure, the relay UE in the connected state will receive and store the system information sent by the network device. The method for the relay UE in the connected state to receive the system information sent by the network device can be: the relay UE in the connected state obtains the system information required by the remote UE based on the request, or the relay UE in the connected state obtains the system information required by the remote UE actively sent by the network device. Based on this, when the remote UE in the idle state or the inactive state requests any system information from the relay UE in the connected state, the relay UE in the connected state can obtain the system information requested by the remote UE in the idle state or the inactive state from the network device and forward it to the remote UE, thereby ensuring that the remote UE can successfully request any system information and ensuring the stability of communication.

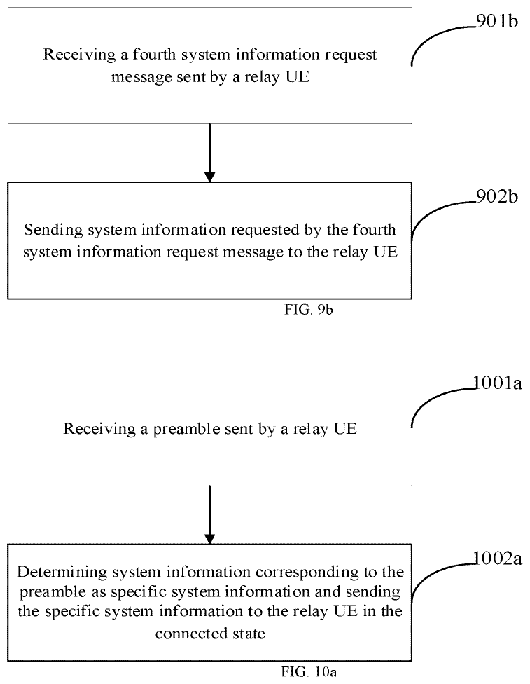

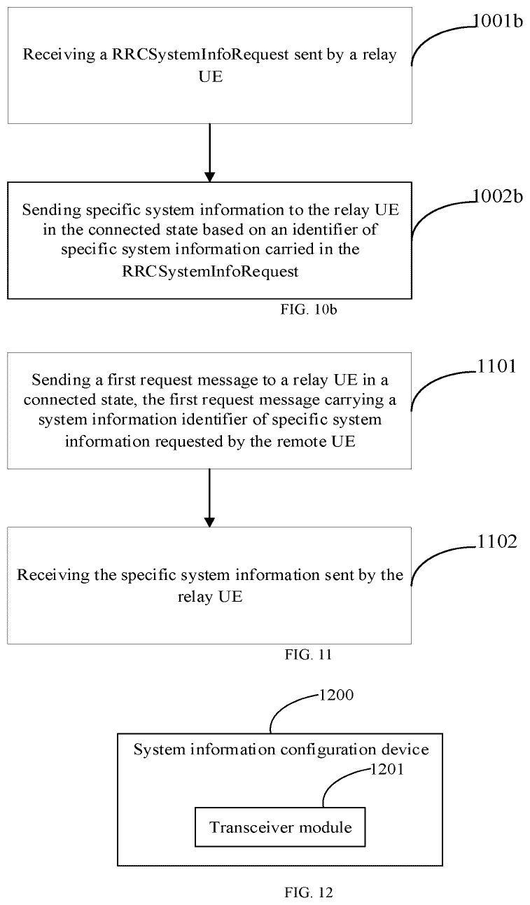

FIG. 10a is a flow chart of a system information configuration method provided by an embodiment of the present disclosure, which is applied to a network device. As shown in FIG. 10a, the system information configuration method may include the following steps:
Step 1001a, receiving a preamble sent by a relay UE.
Step 1002a, determining system information corresponding to the preamble as specific system information and sending the specific system information to the relay UE in the connected state.

For the relevant introduction of steps 1001a to 1002a, reference may be made to the above-mentioned embodiment description.

In summary, in the system information configuration method provided by an embodiment of the present disclosure, a relay UE in a connected state receives and stores the system information sent by a network device. The method for a relay UE in a connected state to receive the system information sent by a network device may be: the relay UE in the connected state obtains the system information required by the remote UE based on the request, or the relay UE in the connected state obtains the system information required by the remote UE actively sent by the network device. Based on this, when a remote UE in an idle state or an inactive state requests any system information from a relay UE in a connected state, the relay UE in the connected state can obtain the system information requested by the remote UE in the idle state or the inactive state from the network device and forward it to the remote UE, thereby ensuring that the remote UE can successfully request any system information and ensuring the stability of communication.

FIG. 10b is a flow chart of a system information configuration method provided in an embodiment of the present disclosure, which is applied to a network device. As shown in FIG. 10b, the system information configuration method may include the following steps:
Step 1001b, receiving a RRCSystemInfoRequest sent by a relay UE.
Step 1002b, sending specific system information to the relay UE in the connected state based on an identifier of specific system information carried in the RRCSystemInfoRequest.

Specifically, the network device can determine the specific system information requested by the relay UE based on the identifier carried in the RRCSystemInfoRequest, and then send the determined specific system information to the relay UE.

The relevant introduction of steps 1001b-1002b can refer to the description of the above embodiment.

In summary, in the system information configuration method provided in the embodiment of the present disclosure, the relay UE in the connected state will receive and store the system information sent by the network device. The method for the relay UE in the connected state to receive the system information sent by the network device can be: the relay UE in the connected state obtains the system information required by the remote UE based on the request, or the relay UE in the connected state obtains the system information required by the remote UE actively sent by the network device. Based on this, when the remote UE in the idle state or the inactive state requests any system information from the relay UE in the connected state, the relay UE in the connected state can obtain the system information requested by the remote UE in the idle state or the inactive state from the network device and forward it to the remote UE, thereby ensuring that the remote UE can successfully request any system information and ensure the stability of communication.

FIG. 11 is a flow chart of a system information configuration method provided in the embodiment of the present disclosure, which is applied to a remote UE. As shown in FIG. 11, the system information configuration method may include the following steps:
Step 1101, sending a first request message to a relay UE in a connected state, the first request message carrying a system information identifier of specific system information requested by the remote UE.
Step 1102, receiving the specific system information sent by the relay UE.

The relevant introduction of steps 1101 to 1102 can refer to the description of the above embodiment.

In summary, in the system information configuration method provided in the embodiment of the present disclosure, the relay UE in the connected state will receive and store the system information sent by the network device. The method for the relay UE in the connected state to receive the system information sent by the network device can be: the relay UE in the connected state obtains the system information required by the remote UE based on the request, or the relay UE in the connected state obtains the system information required by the remote UE actively sent by the network device. Based on this, when the remote UE in the idle state or the inactive state requests any system information from the relay UE in the connected state, the relay UE in the connected state can obtain the system information requested by the remote UE in the idle state or the inactive state from the network device and forward it to the remote UE, thereby ensuring that the remote UE can successfully request any system information and ensure the stability of communication.

FIG. 12 is a structural schematic diagram of a communication device provided in the embodiment of the present disclosure. As shown in FIG. 12, the communication device includes:
a transceiver module, configured to receive and store the system information sent by the network device.

In summary, in the communication device provided in the embodiment of the present disclosure, the relay UE in the connected state will receive and store the system information sent by the network device. The method for the relay UE in the connected state to receive the system information sent by the network device can be: the relay UE in the connected state obtains the system information required by the remote UE based on the request, or the relay UE in the connected state obtains the system information required by the remote UE actively sent by the network device. Based on this, when the remote UE in the idle state or the inactive state requests any system information from the relay UE in the connected state, the relay UE in the connected state can obtain the system information requested by the remote UE in the idle state or the inactive state from the network device and forward it to the remote UE, thereby ensuring that the remote UE can successfully request any system information and ensuring the stability of communication.

For example, in one embodiment of the present disclosure, the transceiver module is further configured to:
obtain a first request message sent by a remote UE, the first request message carrying a system information identifier of the specific system information requested by the remote UE;
in response to valid specific system information not being stored in the relay UE, send a second request message to the network device, the second request message is configured to request the specific system information from the network device;
receive the specific system information sent by the network device; and
forward the specific system information to the remote UE.

For example, in one embodiment of the present disclosure, the transceiver module is further configured to:
obtain a first request message sent by a remote UE, the first request message carrying a system information identifier of specific system information requested by the remote UE;
in response to valid specific system information being stored in the relay UE, sending the valid specific system information stored by the relay UE to the remote UE.

For example, in one embodiment of the present disclosure, the transceiver module is further configured to at least one of:
receive the first type of system information sent by the network device based on the request of the third system information request message, the first type of system information including system information that the relay UE in the connected state can indicate through the third system information request message;
receive system information other than the first type of system information sent by the network device based on the request of the fourth system information request message; and
receive system information other than the first type of system information sent by the network device.

For example, in one embodiment of the present disclosure, the second request message includes a third system information request message or a fourth system information request message;

The transceiver module is further configured to:
in response to the specific system information belonging to the first type of system information, send the third system information request message to the network device; and
in response to the specific system information not belonging to the first type of system information, sending the fourth system information request message to the network device.

For example, in one embodiment of the present disclosure, the fourth system information request message includes a preamble or a radio resource control system information request RRCSystemInfoRequest; where there is a corresponding relationship between the preamble and the system information, and the preamble is configured to request the system information corresponding to the preamble;

The transceiver module is further configured to:
in response to the network device configuring a corresponding preamble for the specific system information, send the preamble corresponding to the specific system information to the network device;
in response to the network device not configuring a corresponding preamble for the specific system information, send the RRCSystemInfoRequest to the network device, where the RRCSystemInfoRequest carries the identifier of the specific system information.

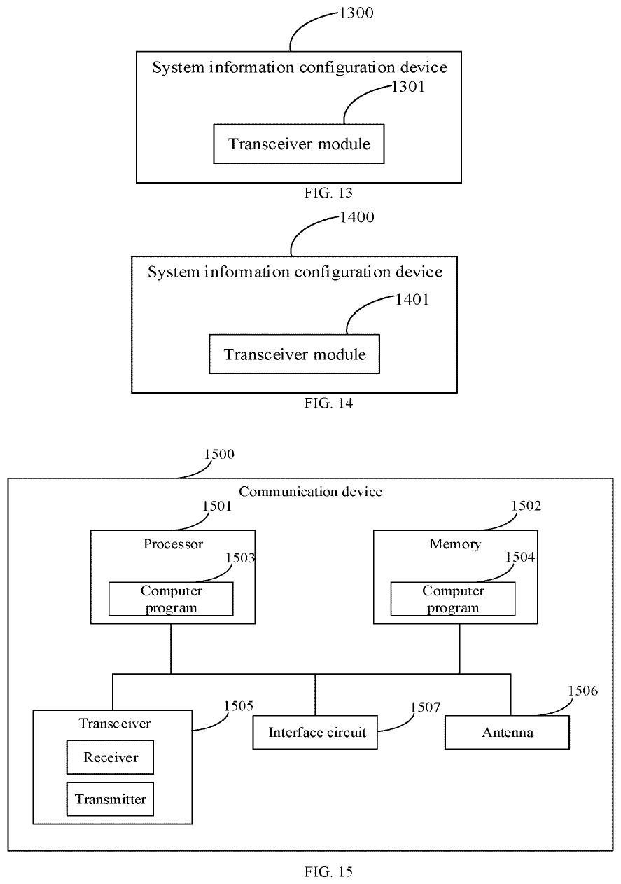

FIG. 13 is a schematic diagram of a structure of a communication device provided by an embodiment of the present disclosure. As shown in FIG. 13, the communication device includes:
a transceiver module configured to send system information to a relay UE in a connected state.

In summary, in the communication device provided by an embodiment of the present disclosure, the relay UE in the connected state receives and stores the system information sent by the network device. The method for the relay UE in the connected state to receive the system information sent by the network device can be: the relay UE in the connected state obtains the system information required by the remote UE based on the request, or the relay UE in the connected state obtains the system information required by the remote UE actively sent by the network device. Based on this, when a remote UE in an idle state or an inactive state requests any system information from a relay UE in a connected state, the relay UE in the connected state can obtain the system information requested by the remote UE in the idle state or the inactive state from the network device and forward it to the remote UE, thereby ensuring that the remote UE can successfully request any system information and ensuring the stability of communication.

For example, in one embodiment of the present disclosure, the transceiver module is further configured to:
receive a second request message sent by the relay UE in the connected state, where the second request message is configured to request the specific system information;
send the specific system information to the relay UE in the connected state.

For example, in one embodiment of the present disclosure, the transceiver module is further configured to:
send the system information requested by the second request message to the relay UE;
send system information other than the first type of system information to the relay UE.

For example, in one embodiment of the present disclosure, the transceiver module is further configured to:
send the first type of system information to the relay UE based on the request of the third system information request message, where the first type of system information includes system information that the relay UE in the connected state can indicate through the third system information request message;
send system information other than the first type of system information to the relay UE based on the request of the fourth system information request message;
send system information other than the first type of system information to the relay UE.

For example, in one embodiment of the present disclosure, the second request message includes a third system information request message or a fourth system information request message.

For example, in one embodiment of the present disclosure, the second request message includes a third system information request message or a fourth system information request message; where the fourth system information request message is only configured to request to obtain the first type of system information.

For example, in one embodiment of the present disclosure, the fourth system information request message includes a preamble or an RRCSystemInfoRequest. There is a corresponding relationship between the preamble and the system information, and the preamble is configured to request the system information corresponding to the preamble;

The transceiver module is further configured to:
in response to the received fourth system information request message being a preamble, determine system information corresponding to the preamble as the specific system information and send it to the relay UE in the connected state;
in response to the received fourth system information request message being an RRCSystemInfoRequest, send the specific system information to the relay UE in the connected state based on the identifier of the specific system information carried in the RRCSystemInfoRequest.

For example, in one embodiment of the present disclosure, the transceiver module is further configured to:
in response to determining that a UE is a relay UE in a connected state, send the system information to the relay UE in the connected state.

For example, in one embodiment of the present disclosure, the transceiver module is further configured to:
in response to determining that a UE requests resource to send a relay discovery message, determine that the UE is a relay UE in a connected state;
in response to determining that a UE requests sending resource for a relay communication, determine that the UE is a relay UE in a connected state;
in response to determining that a UE sends a paging identifier of a remote UE, determine that the UE is a relay UE in a connected state.

FIG. 14 is a structural schematic diagram of a communication device provided in an embodiment of the present disclosure. As shown in FIG. 14, the communication device includes:
a transceiver module, configured to send a first request message to a relay UE in a connected state, where the first request message carries a system information identifier of specific system information requested by a remote UE;
a transceiver module, configured to receive the specific system information sent by the relay UE.

In summary, in the system information configuration device provided in the embodiment of the present disclosure, the relay UE in the connected state will receive and store the system information sent by the network device. The method for the relay UE in the connected state to receive the system information sent by the network device can be: the relay UE in the connected state obtains the system information required by the remote UE based on the request, or the relay UE in the connected state obtains the system information required by the remote UE actively sent by the network device. Based on this, when the remote UE in the idle state or the inactive state requests any system information from the relay UE in the connected state, the relay UE in the connected state can obtain the system information requested by the remote UE in the idle state or the inactive state from the network device and forward it to the remote UE, thereby ensuring that the remote UE can successfully request any system information and ensuring the stability of communication.

Please refer to FIG. 15. FIG. 15 is a structural diagram of a communication device 1500 provided in an embodiment of the present application. The communication device 1500 can be a network device, or a terminal device, or a chip, chip system, or processor that supports the network device to implement the above method, or a chip, chip system, or processor that supports the terminal device to implement the above method. The device can be configured to implement the method described in the above method embodiment, and the details can be referred to the description in the above method embodiment.

The communication device 1500 may include one or more processors 1501. The processor 1501 may be a general-purpose processor or a dedicated processor, etc. For example, it may be a baseband processor or a central processing unit. The baseband processor may be configured to process the communication protocol and the communication data, and the central processing unit may be configured to control the communication device (such as a base station, a baseband chip, a terminal device, a terminal device chip, a DU or a CU, etc.), execute a computer program, and process the data of the computer program.

For example, the communication device 1500 may further include one or more memories 1502, on which a computer program 1504 may be stored, and the processor 1501 executes the computer program 1504 so that the communication device 1500 executes the method described in the above method embodiment. For example, data may also be stored in the memory 1502. The communication device 1500 and the memory 1502 may be provided separately or integrated together.

For example, the communication device 1500 may also include a transceiver 1505 and an antenna 1506. The transceiver 1505 may be referred to as a transceiver unit, a transceiver, or a transceiver circuit, etc., for implementing the transceiver function. The transceiver 1505 may include a receiver and a transmitter. The receiver may be referred to as a receiver or a receiving circuit, etc., for implementing the receiving function. The transmitter may be referred to as a transmitter or a transmitting circuit, etc., for implementing the transmitting function.

For example, the communication device 1500 may further include one or more interface circuits 1507. The interface circuit 1507 is configured to receive code instructions and transmit them to the processor 1501. The processor 1501 runs the code instructions to enable the communication device 1500 to execute the method described in the above method embodiment.

In one implementation, the processor 1501 may include a transceiver for implementing the receiving and transmitting functions. For example, the transceiver may be a transceiver circuit, or an interface, or an interface circuit. The transceiver circuit, interface, or interface circuit for implementing the receiving and transmitting functions may be separate or integrated. The above transceiver circuit, interface, or interface circuit may be configured to read and write code/data, or the above transceiver circuit, interface, or interface circuit may be configured for signal transmission or delivery.

In one implementation, the processor 1501 may store a computer program 1503, which runs on the processor 1501, and enables the communication device 1500 to perform the method described in the above method embodiment. The computer program 1503 may be fixed in the processor 1501, in which case the processor 1501 may be implemented by hardware.

In one implementation, the communication device 1500 may include a circuit, which may implement the functions of sending or receiving or communicating in the above method embodiment. The processor and transceiver described in this application may be implemented on an integrated circuit (IC), an analog IC, a radio frequency integrated circuit RFIC, a mixed signal IC, an application specific integrated circuit (ASIC), a printed circuit board (PCB), an electronic device, etc. The processor and transceiver can also be manufactured using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication device described in the above embodiments may be a network device or a terminal device, but the scope of the communication device described in this application is not limited thereto, and the structure of the communication device may not be limited to FIG. 15. The communication device may be an independent device or may be part of a larger device. For example, the communication device may be:
(1) an independent integrated circuit IC, or a chip, or a chip system or subsystem;
(2) a collection of one or more ICs, for example, the IC collection may also include a storage component for storing data or computer programs;
(3) an ASIC, such as a modem;
(4) a module that can be embedded in other devices;
(5) a receiver, a terminal device, an intelligent terminal device, a cellular phone, a wireless device, a handheld device, a mobile unit, a vehicle-mounted device, a network device, a cloud device, an artificial intelligence device, etc.;
(6) others, etc.

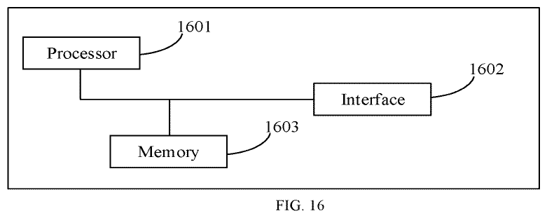

For the case where the communication device may be a chip or a chip system, see the schematic diagram of the chip structure shown in FIG. 16. The chip shown in FIG. 16 includes a processor 1601 and an interface 1602. The number of processors 1601 may be one or more, and the number of interfaces 1602 may be multiple.

For example, the chip further includes a memory 1603, which is configured to store necessary computer programs and data.

Those skilled in the art may also understand that the various illustrative logical blocks and steps listed in the embodiments of the present disclosure may be implemented by electronic hardware, computer software, or a combination of the two. Whether such functions are implemented by hardware or software depends on the specific application and the design requirements of the entire system. Those skilled in the art may use various methods to implement the functions described for each specific application, but such implementation should not be understood as exceeding the scope of protection of the embodiments of the present disclosure.

The present disclosure also provides a readable storage medium having instructions stored thereon, which implement the functions of any of the above method embodiments when executed by a computer.

The present disclosure also provides a computer program product, which implements the functions of any of the above method embodiments when executed by a computer.

In the above embodiments, it can be implemented in whole or in part by software, hardware, firmware or any combination thereof. When implemented using software, it can be implemented entirely or partly in the form of a computer program product. The computer program product includes one or more computer programs. When the computer program is loaded and executed on a computer, the process or function described in the embodiment of the present application is generated in whole or in part. The computer may be a general-purpose computer, a special-purpose computer, a computer network, or other programmable device. The computer program may be stored in a computer-readable storage medium, or transmitted from one computer-readable storage medium to another computer-readable storage medium. For example, the computer program may be transmitted from a website, computer, server or data center by wired (e.g., coaxial cable, optical fiber, digital subscriber line (DSL)) or wireless (e.g., infrared, wireless, microwave, etc.) mode to another website, computer, server or data center. The computer-readable storage medium may be any available medium that a computer can access or a data storage device such as a server or data center that includes one or more available media integrated. The available medium may be a magnetic medium (e.g., a floppy disk, a hard disk, a tape), an optical medium (e.g., a high-density digital video disc (DVD)), or a semiconductor medium (e.g., a solid state disk (SSD)), etc.

Those skilled in the art may understand that the various digital numbers such as the first and second in the present disclosure are only used for the convenience of description, and are not used to limit the scope of the embodiments of the present disclosure, and also indicate the order of precedence.

“At least one” in the present disclosure may also be described as one or more, and the plurality may be two, three, four or more, which is not limited in the present disclosure. In the embodiments of the present disclosure, for one type of technical feature, the technical features in the type of technical feature are distinguished by “first”, “second”, “third”, “A”, “B”, “C” and “D”, etc., and there is no order of precedence or size between the technical features described by the “first”, “second”, “third”, “A”, “B”, “C” and “D”.

The corresponding relationships shown in the tables in the present disclosure may be configured or predefined. The values of the information in each table are only examples and may be configured as other values, which are not limited in the present disclosure. When configuring the corresponding relationship between information and parameters, it is not necessary to configure all the corresponding relationships illustrated in each table. For example, in the table in the present disclosure, the corresponding relationships shown in some rows may not be configured. For another example, appropriate deformation adjustments can be made based on the above table, such as splitting, merging, etc. The names of the parameters shown in the titles of the above tables can also use other names that can be understood by the communication device, and the values or representations of the parameters can also be other values or representations that can be understood by the communication device. When implementing the above tables, other data structures can also be used, such as arrays, queues, containers, stacks, linear lists, pointers, linked lists, trees, graphs, structures, classes, heaps, hash tables or hash tables.

“Predefined” in the present disclosure can be understood as definition, pre-definition, storage, pre-storage, pre-negotiation, pre-configuration, curing, or pre-burning.

Those skilled in the art can realize that the units and algorithm steps of each example described in combination with the embodiments of the present disclosure can be implemented in electronic hardware, or a combination of computer software and electronic hardware. Whether these functions are executed in hardware or software depends on the specific application and design constraints of the technical solution. Those skilled in the art can use different methods to implement the described functions for each specific application, but such implementation should not be considered to be beyond the scope of the present disclosure.

Those skilled in the art can clearly understand that for the convenience and simplicity of description, the specific working process of the system, device and unit described above can refer to the corresponding process in the aforementioned method embodiment, and will not be repeated here.

The above is only a specific implementation method of the present disclosure, but the protection scope of the present disclosure is not limited to this. Those skilled in the art can easily think of changes or replacements within the technical scope disclosed in this application, which should be covered within the scope of protection of the present disclosure. Therefore, the scope of protection of the present disclosure shall be based on the scope of protection of the claims.

1. A method for configuring system information, performed by a relay user equipment (UE) in a connected state, comprising:
receiving and storing the system information sent by a network device.

2. The method according to claim 1, wherein the method further comprises:
obtaining a first request message sent by a remote UE, wherein the first request message carries a system information identifier of specific system information requested by the remote UE;
in response to the relay UE not storing valid specific system information, sending a second request message to the network device, wherein the second request message is configured to request the specific system information from the network device;
receiving the specific system information sent by the network device; and
forwarding the specific system information to the remote UE.

3. The method according to claim 1, wherein the method further comprises:
obtaining a first request message sent by a remote UE, wherein the first request message carries a system information identifier of specific system information requested by the remote UE; and
in response to the relay UE storing valid specific system information, sending the valid specific system information stored by the relay UE to the remote UE.

4. The method according to claim 1, wherein receiving the system information sent by the network device comprises at least one or more of:
based on a request of a third system information request message, receiving a first type of system information sent by the network device, wherein the first type of system information comprises system information that the relay UE in the connected state is able to indicate through the third system information request message;
based on a request of a fourth system information request message, receiving system information other than the first type of system information sent by the network device; and
receiving the system information other than the first type of system information sent by the network device.

5. The method according to claim 2, wherein the second request message comprises a third system information request message or a fourth system information request message;
sending the second request message to the network device comprises:
in response to the specific system information belonging to a first type of system information, sending the third system information request message to the network device; and
in response to the specific system information not belonging to the first type of system information, sending the fourth system information request message to the network device.

6. The method according to claim 5, wherein the fourth system information request message comprises a preamble or a radio resource control system information request (RRCSystemInfoRequest), wherein there is a corresponding relationship between the preamble and the system information, and the preamble is configured to request the system information corresponding to the preamble;
sending the fourth system information request message to the network device comprises:
in response to the network device configuring a corresponding preamble for the specific system information, sending the preamble corresponding to the specific system information to the network device; and
in response to the network device not configuring a corresponding preamble for the specific system information, sending the RRCSystemInfoRequest to the network device, wherein the RRCSystemInfoRequest carries the identifier of the specific system information.

7. A method for configuring system information, performed by a network device, comprising:
sending system information to a relay user equipment (UE) in a connected state.

8. The method according to claim 7, wherein the method further comprises:
receiving a second request message sent by the relay UE in the connected state, wherein the second request message is configured to request specific system information; and
sending the specific system information to the relay UE in the connected state.

9. The method according to claim 7, wherein sending the system information to the relay UE in the connected state comprises at least one of:
based on a request of a third system information request message, sending a first type of system information to the relay UE, wherein the first type of system information comprises system information that the relay UE in the connected state is able to indicate through the third system information request message;
based on a request of a fourth system information request message, sending system information other than the first type of system information to the relay UE; and
sending the system information other than the first type of system information to the relay UE.

10. The method according to claim 8, wherein the second request message comprises a third system information request message or a fourth system information request message.

11. The method according to claim 10, wherein the fourth system information request message comprises a preamble or radio resource control system information request (RRCSystemInfoRequest), wherein there is a corresponding relationship between the preamble and the system information, and the preamble is configured to request the system information corresponding to the preamble;
sending the specific system information to the relay UE in the connected state comprises:
in response to the received fourth system information request message being a preamble, determining the system information corresponding to the preamble as the specific system information and sending it to the relay UE in the connected state; and
in response to the received fourth system information request message being an RRCSystemInfoRequest, sending the specific system information to the relay UE in the connected state based on an identifier of the specific system information carried in the RRCSystemInfoRequest.

12. The method according to claim 7, wherein sending the system information to the relay UE in the connected state comprises:
in response to determining that a UE is a relay UE in a connected state, sending the system information to the relay UE in the connected state.

13. The method according to claim 12, wherein determining that the UE is the relay UE in the connected state comprises at least one or more of:
in response to determining that the UE requests resource to send a relay discovery message, determining that the UE is the relay UE in the connected state;
in response to determining that the UE requests sending resource for a relay communication, determining that the UE is the relay UE in the connected state; and
in response to determining that the UE sends a paging identifier of a remote UE, determining that the UE is the relay UE in the connected state.

14. A method for configuring system information, performed by a remote user equipment (UE), comprising:
sending a first request message to a relay UE in a connected state, wherein the first request message carries a system information identifier of specific system information requested by the remote UE; and
receiving the specific system information sent by the relay UE.

15-17. (canceled)

18. A communication device, comprising a processor and a memory, wherein the memory stores a computer program, and the device is configured to perform the method according to claim 1 upon the processor executing the computer program stored in the memory.

19. A communication device, comprising a processor and an interface circuit, wherein the interface circuit is configured to receive a code instruction and transmit it to the processor;
the processor is configured to run the code instruction to perform the method according to claim 1.

20. (canceled)

21. A communication device, comprising a processor and a memory, wherein the memory stores a computer program, and the device is configured to perform the method according to claim 7 upon the processor executing the computer program stored in the memory.

22. A communication device, comprising a processor and a memory, wherein the memory stores a computer program, and the device is configured to perform the method according to claim 14 upon the processor executing the computer program stored in the memory.

23. A communication device, comprising a processor and an interface circuit, wherein the interface circuit is configured to receive a code instruction and transmit it to the processor, and
the processor is configured to run the code instruction to perform the method according to claim 7.

24. A communication device, comprising a processor and an interface circuit, wherein the interface circuit is configured to receive a code instruction and transmit it to the processor, and
the processor is configured to run the code instruction to perform the method according to claim 14.
